(19) United States
(12) Patent Application Publication
(10) Pub. No.: US 2006/0180367 A1
(43) Pub. Date: Aug. 17, 2006

(54) Vehicle fuel tank with two ingress fuel conduits

(76) Inventor: John Hudak, Akron, OH (US)

Correspondence Address: BROUSE MCDOWELL LPA, 388 SOUTH MAIN STREET, SUITE 500, AKRON, OH, 44311, US

(21) Appl. No.: 11/350,694

(22) Filed: Feb. 9, 2006

Related U.S. Application Data
(60) Provisional application No. 60/652,090, filed on Feb. 11, 2005.

(51) Int. Cl. B60K 15/01

(52) U.S. Cl. 180/69.4

(57) ABSTRACT

A fuel tank for a self propelled motor vehicle includes first and second fuel ingress conduits each attached at one end to the fuel tank and at the other end to the side of the motor vehicle, preferably on opposite sides of the motor vehicle. The first and second fuel ingress conduits are arranged with respect to the motor vehicle to facilitate filling of the fuel tank from a fuel source positioned external to the motor vehicle on either side of the motor vehicle.

This application claims priority to U.S. provisional application Ser. No. 60/652,090, entitled VEHICLE FUEL TANK WITH TWO INGRESS FUEL CONDUITS, filed Feb. 11, 2005, which is incorporated herein by reference.

### I. BACKGROUND OF THE INVENTION

A. Field of Invention

This invention pertains to the art of vehicle fuel systems.

B. Description of the Related Art

It is known in the art to provide vehicles having fuel tanks with a single ingress conduit for filling the fuel tank from an outside fuel source such as a service station fuel pump. The single ingress conduit typically has an entrance located at one side of the vehicle. The entrance may be covered with a removable cap to selectively allow access into the conduit. Positioning the conduit entrance at the side of the vehicle may impart certain advantages over designs in which the single ingress conduit entrance is positioned at the rear of the vehicle. However, by placing the conduit opening at the side of the vehicle, access to typical fuel sources for filling the fuel tank, namely, fuel pumps, can be restricted. Vehicles must be driven to a position adjacent the fuel pump in a particular orientation that additionally places the single ingress opening adjacent the fuel pump. In the event that the vehicle is not appropriately orientated with respect to the fuel pump, the operator must either attempt to stretch the fuel pump hose to the conduit opening, or reposition the vehicle into an appropriate orientation.

Stretching the fuel hose can result in fuel spills as well as damages to the hose and its connections. Repositioning the vehicle can prove difficult within the confines of a fueling station, which may have multiple obstacles, including additional pumps, signage, curbs, and other parked or moving vehicles. This creates inefficiencies in fueling vehicles, congestion at the fueling station, and the potential for accidents between vehicles and between vehicles and pedestrians.

It would be advantageous if vehicles could be fueled through ingress conduits having entrances positioned at each side of the vehicle. In this way, the specific orientation of the vehicle with respect to the fuel pump would be rendered less important, since essentially any vehicle orientation would provide access to an ingress conduit for filling the vehicle fuel tank, as long as the vehicle is positioned adjacent the fuel pump.

It is known to provide a generator set for refrigerator trailers with fuel tanks capable of being fueled from the top of the tanks at both sides as shown and described in U.S. Pat. No. 5,673,788.

Also, a single fuel tank fill pipe for motorcycles is shown and described in U.S. Pat. No. 4,424,839 wherein the single fill pipe has two small inlets inside the pipe to provide a viewing window for monitoring the fuel level during filling of the tank.

The present invention provides methods and apparatuses for filling a fuel tank for a vehicle from either side of the vehicle with fuel conduits extending from the tank to both sides of the vehicle. Each of the fuel conduits may be provided with an entrance opening for fueling the vehicle at that side of the vehicle. The difficulties in maneuvering the vehicle to position an entrance opening adjacent a fuel pump, as in the prior art, are therefore, overcome in a way that is simple and efficient while providing safety and time savings in the fueling process.

### II. SUMMARY OF THE INVENTION

According to one aspect of the present invention, an improved fuel system is provided which may be used on any vehicle.

According to another aspect of the invention, the fuel system may include a fuel tank and at least first and second fuel ingress conduits.

According to still another aspect of the invention, the fuel system may include first and second fuel ingress conduits, each having an opening that is accessible from the side of the vehicle.

According to still another aspect of the invention, the openings of the first and second fuel ingress conduit may be accessible from opposite sides of the vehicle.

According to another aspect of the invention, each of the first and second fuel ingress conduits may be provided with an opening adapted for receiving fuel from a fuel source.

According to another aspect of the invention, a vehicle having a fuel system that includes a fuel tank and first and second fuel ingress conduits is taught.

According to another aspect of the invention, the vehicle may include first and second access doors for accessing the first and second fuel ingress conduit openings respectively.

Still other benefits and advantages of the invention will become apparent to those skilled in the art to which it pertains upon reading and understanding of the following detailed description.

### III. BRIEF DESCRIPTION OF THE DRAWINGS

The invention may take physical form in certain parts and arrangement of parts, at least one embodiment of which will be described in detail in this specification and illustrated in the accompanying drawings which form a part hereof and wherein;

FIG. 1 is a perspective view of a motor vehicle with parts being broken away to showing the fuel system embodying the present invention.

FIG. 2 is a perspective view of the fuel tank showing two fuel ingress conduits.

### IV. DESCRIPTION OF THE INVENTION

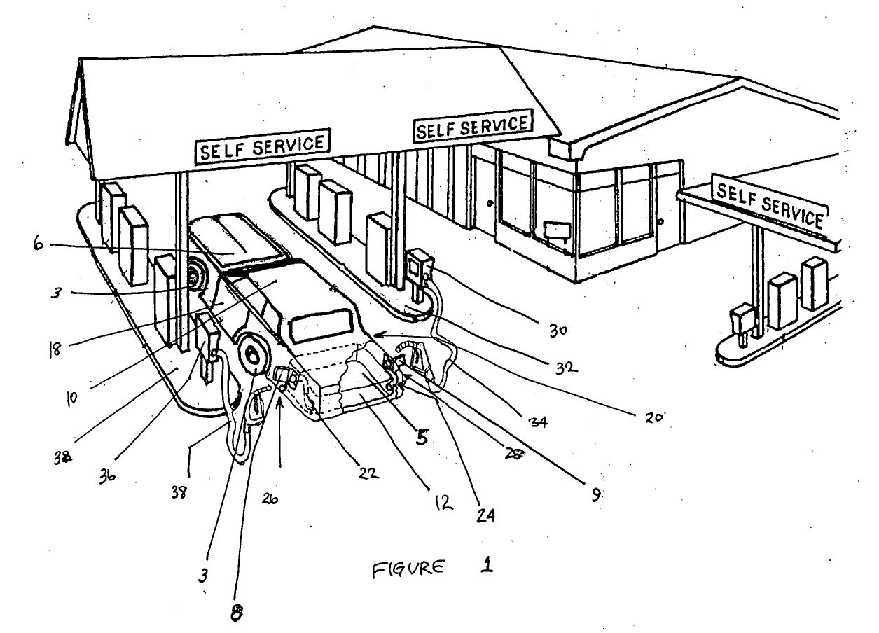

Referring now to the drawings wherein the showings are for purposes of illustrating at least one embodiment of the invention only and not for purposes of limiting the same, FIG. 1 shows a vehicle 10 with parts broken away to reveal a fuel system 5, including a fuel tank 12, which is shown mounted at the rear of the vehicle 10, but may be located elsewhere in the vehicle 10 in accordance with sound engineering judgment. The vehicle 10 may be a passenger automobile. The vehicle 10, may be a passenger truck, such as a sport utility vehicle, van, or pick up truck. The vehicle 10 may also be a commercial vehicle, such as a dump truck, limousine, or other utility vehicle. The vehicle 10 may include a frame (not shown), at least a first, and preferably a plurality of ground engaging wheels 3 operatively communicated to the frame, and a vehicle body 6 mounted to the frame in a manner that is well known in the art for vehicles 10. The vehicle 10 may also include a payload region such as a trunk or as in the case of a pick-up truck, a truck bed (not shown). The fuel system 5, may also include at least first and second fuel ingress conduits 22, 24 suitable for channeling fuel from a fuel source located outside of the vehicle 10, to the fuel tank 12. The first and second fuel ingress conduits may operatively extend from the fuel tank 12 to mounting positions located on the body 6 of the vehicle 10, preferably along the sides of the vehicle 10, and more preferably, along opposite sides of the vehicle 10. First and second access panels 8, 9 operatively connected to the body 6 of the vehicle 10 may provide cover and selective access to the respective openings of the first and second fuel ingress conduits 22, 24.

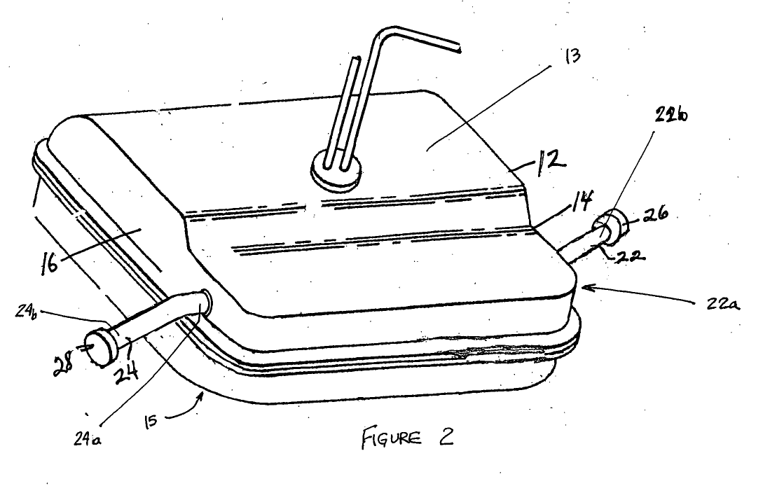

With reference to FIG. 2, the fuel tank 12 of the fuel system 5 may include side walls 11, a top portion 13 and a fuel tank bottom 15. The fuel tank side walls 11 may include a left side 14 and a right side 16 in a substantially parallel relationship to a left side 18 and a right side 20 of the vehicle 10 respectively. However, it is noted here that any configuration of fuel tank 12 and sides 14, 16 may be chosen with sound engineering judgment as is appropriate for use with the present invention. Accordingly, the fuel system 5 may include a left side fuel ingress conduit 22 having first 22a and second 22b ends, wherein the first end 22a is mounted at the left side 14 of the fuel tank 12. The fuel system 5 may further include a right side fuel ingress conduit 24 having first 24a and second 24b ends, wherein the first end 24a is mounted at the right side 16 of the fuel tank 12. The second end 22b of the left side fuel ingress conduit 22 may extend from the left side 14 of the fuel tank 12 to the left side 18 of the vehicle 10. In this manner, the second end 22b may be mounted to the body of the vehicle 6 such that the conduit opening is accessible to the operator during the fueling process. In a similar manner, the second end 24b of the right side fuel ingress conduit 24 may extend from the right side 16 of the fuel tank 12 to the right side 20 of the vehicle 10. Removable fuel caps 26 and 28 may be included for covering the conduit openings of the left side fuel ingress conduit 22 and the right side ingress conduit 24 respectively, as shown in FIG. 1.

With reference again to FIGS. 1 and 2, in operation, the vehicle 10, which may be an automobile, may be driven to a fueling position next to a fuel pump 30 on the right side of the vehicle 10 located on an island 32 of a gas station. The vehicle 10 may be fueled by opening access panel 9, removing the cap 28 from the right side fuel ingress conduit 24, inserting a hose 34 into the conduit opening of the fuel ingress conduit 24 and pumping the fuel into the fuel tank 12. In the event that the fuel pump 30 on the right side of the vehicle 10 is occupied or otherwise unavailable, the operator may drive the vehicle 10 in the same direction but toward the fuel pump 36 located on an island 38 of the gas station on the left side of the vehicle 10. The operator may fuel the vehicle 10 by opening access panel 8, removing the cap 26 and inserting a hose 38 into the left side fuel ingress conduit 22. In this manner the vehicle 10 such as an automobile may be refueled from either the left side or the right side of the vehicle 10. The vacant pump spaces may be utilized regardless of the position of the pump whether on the right side or the left side of the vehicle 10. This can be done without having to turn the vehicle 10 around so that the fuel ingress conduit of the fuel tank 12 is adjacent the pump.

At least one embodiment has been described herein and above, however it will be apparent to those skilled in the art that the above methods and apparatuses may incorporate changes and modifications without departing from the general scope of this invention. It is intended to include all such modifications and alterations insofar as they come within the scope of the appended claims or the equivalence thereof.

I/We claim:

1. A fuel system for a vehicle comprising:
a fuel tank,
at least first and second fuel ingress conduits, each of said first and second fuel ingress conduits having a first end attached to the fuel tank, and a second end adapted to be positioned along a side of the associated vehicle.

2. The fuel system of claim 1, wherein the second end of the first fuel ingress conduit is adapted to be fixedly positioned along a first side of the associated vehicle, and the second end of the second fuel ingress conduit is adapted to be fixedly positioned along a second side of the associated vehicle.

3. The fuel system of claim 2, wherein the second ends of the first and second fuel ingress conduits are adapted to receive a fuel hose nozzle.

4. The fuel system of claim 3 further comprising first and second caps, wherein said first and second caps are adapted to be removably received by the second ends of the first and second fuel conduits.

5. The fuel system of claim 4, wherein the fuel system is adapted to be operatively received into an automobile.

6. A vehicle, comprising:
a vehicle frame;
at least a first ground engaging wheel operatively, rotatably connected with respect to the vehicle frame;
an engine fixedly attached to the vehicle frame;
a fuel tank operatively communicated to the engine for use in supplying associated fuel to the engine; and,
wherein the fuel tank includes a first ingress fuel conduit and a second ingress fuel conduit, each adapted to channel fuel from a fuel source located outside of the vehicle frame to the fuel tank.

7. The vehicle of claim 6, wherein the vehicle an automobile.

8. The vehicle of claim 6, wherein the vehicle is a passenger truck.

9. A passenger vehicle comprising:
a vehicle frame;
a vehicle body fixedly attached to the frame;
at least a first ground engaging wheel operatively, rotatably connected with respect to the vehicle frame;
an engine fixedly attached to the vehicle frame;
a fuel tank operatively communicated to the engine for use in supplying associated fuel to the engine;
at least first and second fuel ingress conduits, each of said first and second fuel ingress conduits having a first end attached to the fuel tank, and a second end adapted to be positioned along first and second opposite sides of the body of the vehicle.

10. The passenger vehicle of claim 9, wherein the second end of the first fuel ingress conduit is adapted to be fixedly positioned along a first side of the body of the vehicle, and the second end of the second fuel ingress conduit is adapted to be fixedly positioned along a second side of the body of the vehicle.
